(19) United States
(12) Patent Application Publication
(10) Pub. No.: US 2026/0065597 A1
(43) Pub. Date: Mar. 5, 2026

(54) POLYLINE ESTIMATION

(71) Applicant: QUALCOMM Incorporated, San Diego, CA (US)

(72) Inventors: Varun RAVI KUMAR, San Diego, CA (US); Shubhankar Mangesh BORSE, San Diego, CA (US); Senthil Kumar YOGAMANI, San Diego, CA (US)

(21) Appl. No.: 18/824,774

(22) Filed: Sep. 4, 2024

(51) Int. Cl. G06T 17/30; G06T 19/20

(52) U.S. Cl. CPC G06T 17/30; G06T 19/20; G06T 2219/2021

(57) ABSTRACT

Systems and techniques are described herein for refining polylines. For instance, a method for refining polylines is provided. The method may include generating a polyline trajectory based on a point-cloud representation of a scene; generating a plurality of polyline segments based on the polyline trajectory; processing the plurality of polyline segments to generate a plurality of polyline-segment features; determining a relationship associated with polylines of the polyline trajectory based on the plurality of polyline-segment features; updating a polyline-segment feature of the plurality of polyline-segment features based on the relationship; and processing the plurality of polyline-segment features to generate a refined polyline trajectory.

### TECHNICAL FIELD

The present disclosure generally relates to relates to high-definition (HD)-maps. For example, aspects of the present disclosure include systems and techniques for estimating polylines for vectorized HD maps.

### BACKGROUND

High definition (HD) maps may be useful for autonomous, semi-autonomous, and driver assistance systems. For example, HD maps may be used for motion planning because HD maps include information about roads like lane boundaries, road boundaries, pedestrian crossings, and lane dividers. Vectorized-HD-map methods focus on generating polylines and polygons to represent objects such as lane boundaries, road boundaries, pedestrian crossings, and lane dividers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for refining polylines. According to at least one example, a method is provided for refining polylines. The method includes: generating a polyline trajectory based on a point-cloud representation of a scene; generating a plurality of polyline segments based on the polyline trajectory; processing the plurality of polyline segments to generate a plurality of polyline-segment features; determining a relationship associated with polylines of the polyline trajectory based on the plurality of polyline-segment features; updating a polyline-segment feature of the plurality of polyline-segment features based on the relationship; and processing the plurality of polyline-segment features to generate a refined polyline trajectory.

In another example, an apparatus for refining polylines is provided that includes at least one memory and at least one processor (e.g., configured in circuitry) coupled to the at least one memory. The at least one processor configured to: generate a polyline trajectory based on a point-cloud representation of a scene; generate a plurality of polyline segments based on the polyline trajectory; process the plurality of polyline segments to generate a plurality of polyline-segment features; determine a relationship associated with polylines of the polyline trajectory based on the plurality of polyline-segment features; update a polyline-segment feature of the plurality of polyline-segment features based on the relationship; and process the plurality of polyline-segment features to generate a refined polyline trajectory.

In another example, a non-transitory computer-readable medium is provided that has stored thereon instructions that, when executed by one or more processors, cause the one or more processors to: generate a polyline trajectory based on a point-cloud representation of a scene; generate a plurality of polyline segments based on the polyline trajectory; process the plurality of polyline segments to generate a plurality of polyline-segment features; determine a relationship associated with polylines of the polyline trajectory based on the plurality of polyline-segment features; update a polyline-segment feature of the plurality of polyline-segment features based on the relationship; and process the plurality of polyline-segment features to generate a refined polyline trajectory.

In another example, an apparatus for refining polylines is provided. The apparatus includes: means generating a polyline trajectory based on a point-cloud representation of a scene; means for generating a plurality of polyline segments based on the polyline trajectory; means for processing the plurality of polyline segments to generate a plurality of polyline-segment features; means for determining a relationship associated with polylines of the polyline trajectory based on the plurality of polyline-segment features; means for updating a polyline-segment feature of the plurality of polyline-segment features based on the relationship; and means for processing the plurality of polyline-segment features to generate a refined polyline trajectory.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes a representation of a top-down view of example polylines and polygons representing objects of a road;

FIG. 2 includes a representation of an example image, as captured by an ego vehicle, overlaid with polylines;

FIG. 3 is a block diagram illustrating an example system for generating polyline segments, according to various aspects of the present disclosure;

FIG. 4 is a block diagram illustrating an example system for generating refined polyline segments, according to various aspects of the present disclosure;

FIG. 5 is a block diagram to provide additional detail regarding the encoder of FIG. 4, according to various aspects of the present disclosure;

FIG. 6 is a block diagram to provide additional detail regarding the memory and the relater of FIG. 4, according to various aspects of the present disclosure;

FIG. 7 is a flow diagram illustrating an example process for estimating polylines, in accordance with aspects of the present disclosure;

FIG. 8 is a block diagram illustrating an example of a deep learning neural network that can be used to perform various tasks, according to some aspects of the disclosed technology;

FIG. 9 is a block diagram illustrating an example of a convolutional neural network (CNN), according to various aspects of the present disclosure; and

FIG. 10 is a block diagram of an example transformer in accordance with some aspects of the disclosure;

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Driving system (e.g., an autonomous, semi-autonomous, or assisted driving systems, which may be referred to herein as an “advanced driver assistance system (ADAS)”) of a vehicle can use map information for various purposes. Map information may important even for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may information from map information to a driver of a vehicle.

An ADAS, according to any level of autonomy, may make use of as high-definition (HD) map of the environments of the vehicle of the ADAS. An HD map may include map points—three-dimensional coordinates of surfaces of roads at a sub-meter granularity. An HD map may also include additional features such as lane markers, road signs, traffic lights, traffic signs, poles, etc. ADASs may use HD maps to make determinations about steering, accelerating, braking, path planning, and/or to provide information to a driver, etc.

In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

HD maps may be useful for ADASs, for example, for motion planning since HD maps include information about the roads like lane boundaries, road boundaries, pedestrian crossings, and lane dividers. Vectorized-HD-map methods focus on generating polylines and polygons to represent objects (such as lane boundaries, road boundaries, pedestrian crossings, and lane dividers). For example, pedestrian crossing can be represented as a polygon and lane boundary can be shown with a polyline. Deep-learning-based methods, which may use geometric transformer modules to generate polylines and/or polygons based on camera perspective views and/or lidar point clouds. In the present disclosure, the term “frames” may refer to image frames captured by a camera and/or to a point cloud captured by a point-cloud system, such as a light detection and ranging (LIDAR) system or a radio detection and ranging (RADAR) system. Frames are examples of “captured representations” of a scene, or of objects in a scene.

A vehicle (or a computing system of the vehicle) may capture frames and the vehicle (e.g., online map generation), or another computing device (e.g., offline map generation), may generate an HD map based on the frames. For example, the vehicle may capture frames including representations of objects (such as lane boundaries, road boundaries, pedestrian crossings, and lane dividers). The vehicle, or the other computing device, may determine polylines and/or polygons to represent the objects. The vehicle, or the other computing device, may store the polylines and/or polygons in an HD map.

Additionally or alternatively, a vehicle (or a computing system of the vehicle), or another computing system, may store an HD map and refine and/or update the HD map based on frames. For example, the vehicle may capture frames including representations of objects. The vehicle, or the other computing system, may determine polylines and/or polygons to represent the objects. The vehicle, or the other computing system, may compare the polylines and/or polygons to the objects in the HD map. Where there are differences between the positions of the objects in the HD map and the positions of the objects as represented by the polylines and polygons, the vehicle, or the other computing system, may determine to rely on the polylines and polygons based on the frames. Additionally or alternatively, the vehicle, or the other computing system, may refine and/or update the HD map.

Some methods for polyline estimation in vectorized HD maps treat each point of frames independently during prediction and do not exploit the intra-instance correlation by analyzing correlations between points of a single polyline. This leads to predictions that lack geometric consistency and smoothness.

Systems, apparatuses, methods (also referred to as processes), and computer-readable media (collectively referred to herein as “systems and techniques”) are described herein for generating, refining, and/or updating map data. For example, the systems and techniques described herein may jointly reason about groups of points and exploit intrinsic relationships between points within a polyline during the estimation process. For instance the systems and techniques may segment polylines into polyline segments then relate points of a given polyline to other points of the same polyline and relate points of a given to points of other polylines. The systems and techniques may model temporal correlations better than other methods.

Other methods may have challenges in capturing local geometric properties (e.g., maintaining smoothness and geometric consistency within individual polyline segments and between neighboring segments), modeling global dependencies (e.g., ensuring that the overall polyline trajectory remains coherent and accurate across its entire length, taking into account dependencies and relationships between distant segments), incorporating environmental context (e.g., leveraging additional information from sources like HD maps to improve the understanding of the surrounding environment and road topology), and/or robust feature representation (e.g., effectively encoding and fusing relevant features from both the initial polyline trajectory and the associated point cloud data).

The systems and techniques may address the above issues and produce more accurate, smooth, and geometrically consistent polyline trajectory estimations. Additionally or alternatively, the systems and techniques may improve the local geometric consistency and global coherence of the estimated polyline trajectories. In this way, the systems and techniques enable producing polyline predictions with accurate geometry and topology, improving map accuracy (both online and offline HD map) for downstream autonomous driving tasks.

The systems and techniques may perform segment-wise feature encoding and fusion. For example, the systems and techniques may encode polyline segments and associated point clouds separately, then fuses their features for each segment. This is different from other methods that aggregate point cloud features globally. Encoding features at the segment level allows capturing localized context and geometry.

Additionally, the systems and techniques may reason jointly about groups of points. For example, the systems and techniques take a novel approach to jointly reason about groups of points within a polyline, allowing for the exploitation of intrinsic relationships between points to improve polyline estimation in vectorized HD maps.

The systems and techniques may include, memory modules for ubiquitous (local and global) refinement of trajectories. The systems and techniques introduce a novel memory module to refine points in each trajectory, resulting in an ideal polyline trajectory.

For example, the systems and techniques may include a local memory module that focuses on maintaining smoothness and geometric consistency within neighboring segments. By capturing intra-polyline dependencies during the prediction of vectorized HD map elements, the systems and techniques address an open challenge in the field, aiming to produce polyline predictions with accurate geometry and topology.

Additionally, the systems and techniques may include a global memory module that utilizes a Graph Neural Network (GNN) to capture global dependencies and relationships across the entire polyline trajectory. Using the global memory, the systems and techniques may incorporate HD map data as additional contextual information within the global memory module. This allows the systems and techniques to leverage environmental context from HD maps, potentially improving the accuracy and robustness of polyline estimation.

The systems and techniques may perform attention-based inter-segment reasoning. For example, the systems and techniques may use self-attention and multi-head attention (e.g., self-attention or cross-attention) mechanisms to model relationships and dependencies between different polyline segments. This attention-based reasoning enables the systems and techniques to capture complex interactions between segments and update their representations accordingly.

Additionally or alternatively, the systems and techniques may perform endpoint refinement and segment-connection prediction. For example, a decoder of the systems and techniques may predict residual offsets to refine the coordinates of segment endpoints, as well as binary variables indicating connections between adjacent segments. This allows reconstructing the optimal vectorized polyline trajectories while considering both local geometric adjustments and global connectivity.

The combination of segment-wise feature encoding, attention-based inter-segment reasoning, local and global memory modules, HD map integration, and endpoint refinement and segment-connection prediction is novel and provides advantages in polyline-trajectory estimation. For example, segment-wise feature encoding, attention-based inter-segment reasoning, local and global memory modules, HD map integration, and endpoint refinement and segment-connection prediction increase the accuracy of polylines. Increasing the accuracy of polylines may improve the ability of downstream autonomous and/or assisted driving tasks in using the polylines.

The systems and techniques improve polyline estimation in vectorized HD maps by capturing intra-polyline dependencies and exploiting the relationships between points within a polyline. The systems and techniques involve several steps: preprocessing the polyline, storing segments in memory, intra-segment refinement, conditional inter-segment refinement, point-cloud encoding, feature fusion, inter-segment relationship modeling, and polyline decoding.

Preprocessing the polyline may include resampling the polyline. An initial estimation of the polyline can be obtained from off-the-shelf algorithm. The initial estimation may be resampled using spline interpolation to ensure consistent point spacing. Further each polyline segment may be encoded using a multi-layer perceptron (MLP) to extract features. A number (e.g., n) of previous segments may be stored in a memory.

Intra-segment refinement may include local refinement of the trajectories by smoothing segments stored in the memory. This refinement may also be based on known variables such as angle followed during turns. Conditional Inter-segment refinement may include conditioning on other trajectories in the memory using a graph neural network (GNN) and performing a global smoothing to ensure trajectories do overlap one with another. Point-cloud encoding may include using techniques like PointNet and voxelization to learn point features and aligning points to polylines. Feature fusion may include fusing encoded polyline features and point cloud features for each segment to derive final segment features. Inter-segment relationship modeling may include using an attention mechanism to reason about the relationships between different polyline segments and update segment features based on cross-segment reasoning. Polyline decoding may include predicting refined coordinates for each segment endpoint and connections between segments to form the full polyline trajectory.

The systems and techniques produce polyline predictions with accurate geometry and topology. Increasing the accuracy of polylines may improve map accuracy for downstream autonomous and/or assisted driving tasks.

Various aspects of the application will be described with respect to the figures below.

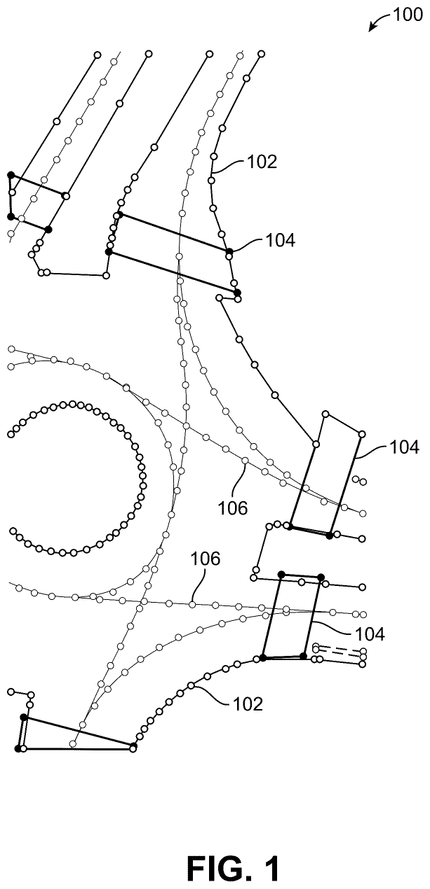

FIG. 1 includes a representation 100 of a top-down view of example polylines and polygons representing objects of a road. For example, representation 100 includes polylines 102 which may represent lane boundaries, polygons 104 that may represent pedestrian crossings, and polylines 106 that may represent lane centerlines. Each of polylines 102, polygons 104, and polylines 106 may be made up of a number of points and/or of lines between the points. Data representing locations of points of polylines 102, polygons 104, and/or polylines 106 may be determined according to various aspects of the present disclosure and may be used to generate, update, and/or refine HD maps.

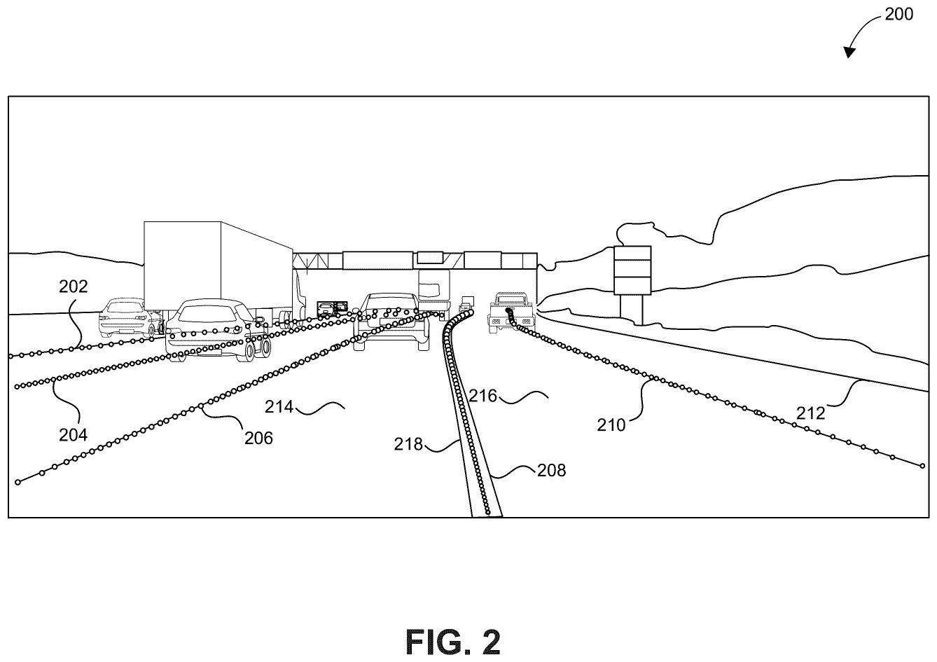

FIG. 2 includes a representation 200 of an example image, as captured by an ego vehicle, overlaid with polylines. Representation 200 includes objects, such as, lane boundary 202, lane boundary 204, lane boundary 206, lane boundary 208, lane boundary 210, road boundary 212, centerline 214, and centerline 216. The objects in representation 200 abstracted from visibly distinct markers. For example, lane boundary 206 may be extrapolated based on a dashed line marking lane boundary 206. As an example, though not visibly marked, lanes may include centerlines (defined between lane boundaries).

Representation 200 is overlaid with polylines points making up polylines. The polylines may be determined based on one or more representations, such as and including representation 200. For example, polyline 218 may be determined based on representation 200 and other representations captured by the same camera at about the same time.

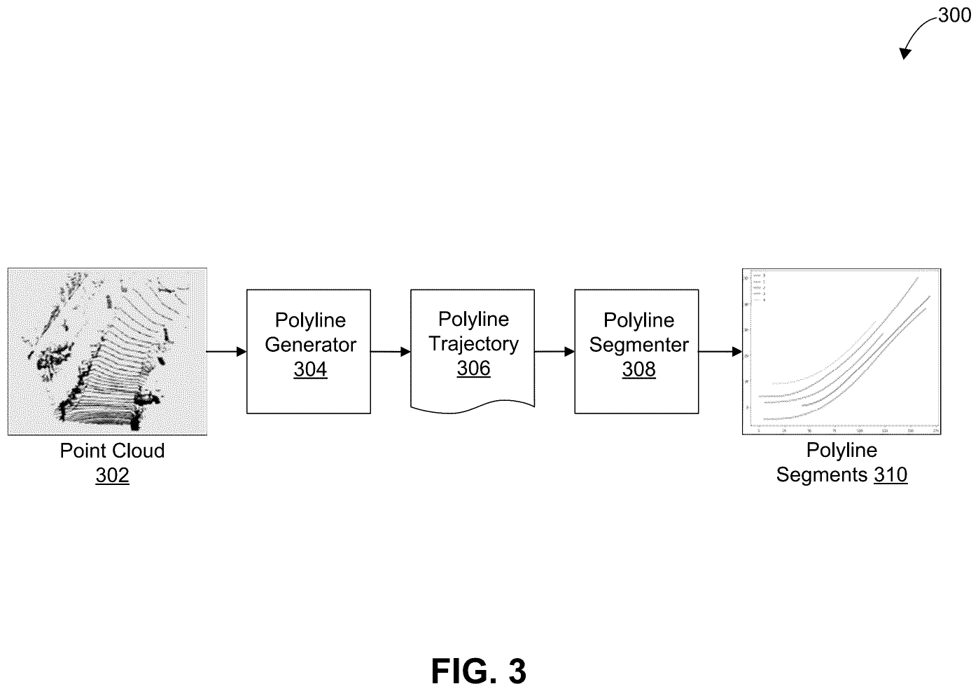

FIG. 3 is a block diagram illustrating an example system 300 for generating polyline segments 310, according to various aspects of the present disclosure. In general, a polyline generator 304 may generate a polyline trajectory 306 based on a point cloud 302 and a polyline segmenter 308 may generate polyline segments 310 based on polyline trajectory 306.

Point cloud 302 may be a point-cloud representation of a scene. Point cloud 302 may be, or may include, a light detection and ranging (LIDAR) point cloud, or a radio detection and ranging (RADAR) point cloud. Point cloud 302 may be captured by a LIDAR system or a RADAR system of a vehicle, for example, as the vehicle travels on a road. Point cloud 302 may include representations of objects, such as, lanes boundaries, road boundaries, dividers, and pedestrian crossings.

Polyline generator 304 may generate polyline trajectory 306 based on point cloud 302. Polyline generator 304 may fit a polynomial equation to lines of points in point cloud 302. Polyline trajectory 306 may be, or may include, a vectorized polyline trajectory P=(p1, p2, . . . pM). For example, polyline generator 304 may specify a set of points, either manually by a user or programmatically through algorithms. These points may then be connected by straight lines to form polylines. In some cases, additional steps may be used to break polylines into smaller segments, especially when applying certain operations like collision detection, where smaller segments can provide more accurate results.

Polyline segmenter 308 may segment polylines of polyline trajectory 306 into polyline segments 310. For example, polyline segmenter 308 may select a predetermined number of points (e.g., 5, 10, or 20) of each polyline of polyline trajectory 306 as a polyline segment. The predetermined number of points that defines a polyline segment may be a hyperparameter.

Breaking polylines into segments (e.g., by polyline segmenter 308) can be achieved through various approaches. One approach is to subdivide each polyline at regular intervals, thereby increasing the granularity of the polyline. Another approach involves detecting specific features within polylines, such as sharp turns or intersections with other lines, and using these features as points to create new segments. These segmented polylines are then used in subsequent processing steps, such as rendering or analysis, where the finer segmentation allows for more detailed and precise operations.

Given the challenges associated with managing and processing polylines, the systems and techniques may improve the efficiency and accuracy of operations related to polyline generation, segmentation, and subsequent manipulation in a digital environment.

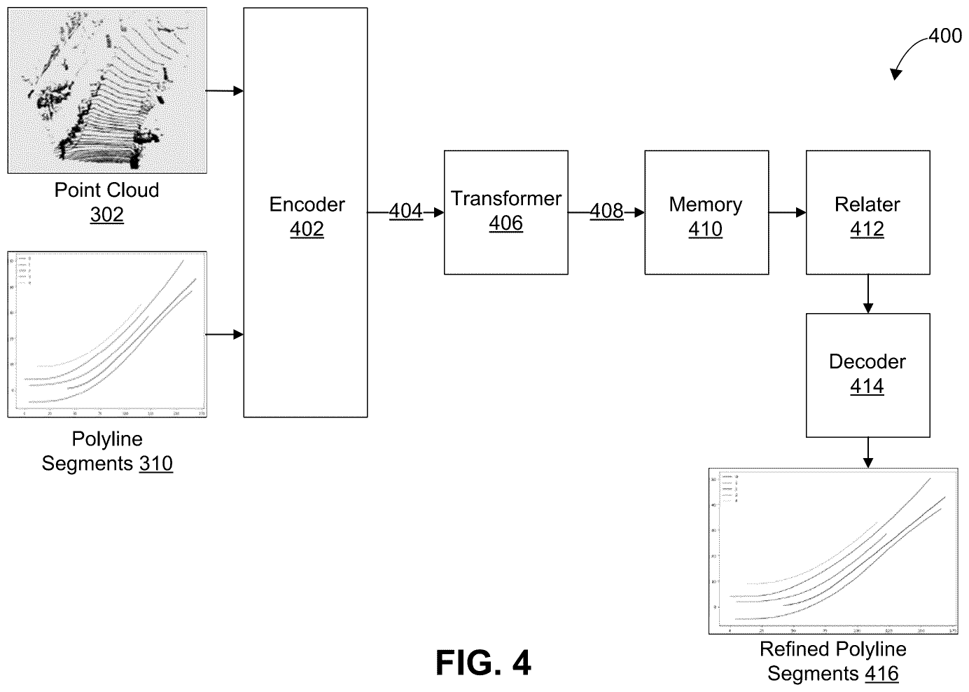

FIG. 4 is a block diagram illustrating an example system 400 for generating refined polyline segments 416, according to various aspects of the present disclosure. In general, system 400 may obtain a point cloud 302 (e.g., of a series of point clouds) and polyline segments 310 based on point cloud 302 (e.g., as determined by the process described with regard to FIG. 3). An encoder 402 may encode and combine point cloud 302 and polyline segments 310 to generate combined features 404. A transformer 406 may process polyline segments based on attention to generate features 408. A memory 410 may store features 408. A relater 412 may relate polyline segments with the same polyline segments from a previously-received instance of point cloud 302 and polyline segments 310 (e.g., intra-segment relationships) and/or with points of other polyline segments (e.g., inter-segment relationships). A decoder 414 may decode features to generate refined polyline segments 416.

Encoder 402 may encoder and combine point cloud 302 and polyline segments 310 in a feature space to generate combined features 404. For example, encoder 402 may encode point cloud 302 as point-cloud features, encode polyline segments 310 as polyline-segment features, and fuse the point-cloud features with the polyline-segment features to generate combined features 404. Encoder 402 may perform per-frame encoding (e.g., encoding each instance of point cloud 302 and/or polyline segments 310 as it is obtained).

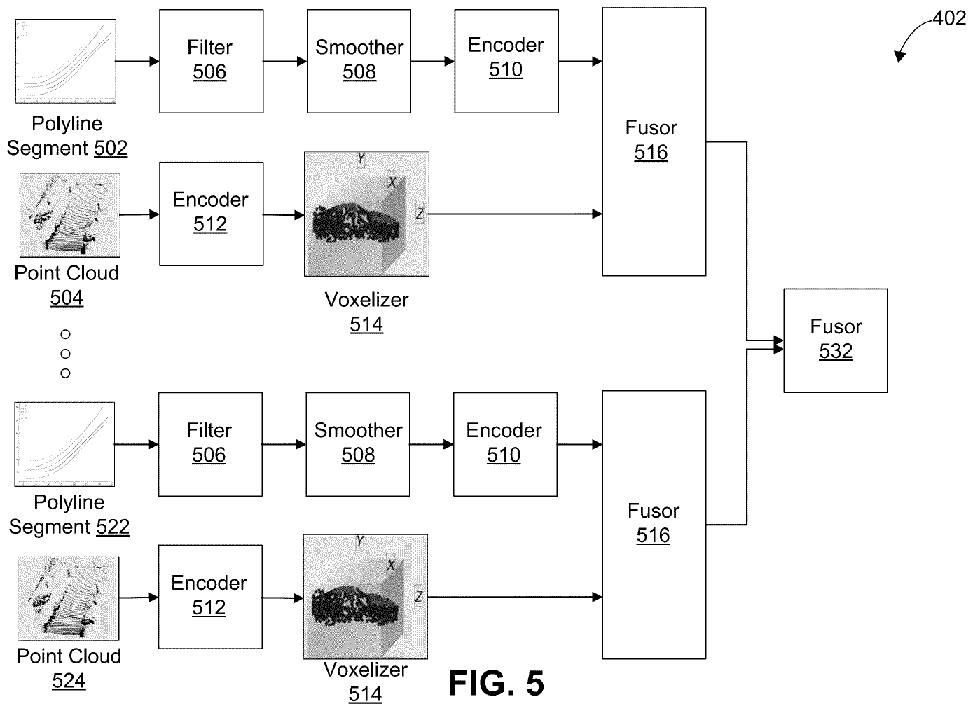

FIG. 5 is a block diagram to provide additional detail regarding encoder 402 of FIG. 4, according to various aspects of the present disclosure. Encoder 402 may be, or may include, a per-frame encoder. For example, encoder 402 may encoder polyline segments and point clouds for each point cloud frame of a number of point cloud frames (e.g., as the point cloud frames are received). For example, encoder 402 may encode polyline segment 502 and point cloud 504. Further, encoder 402 may encode polyline segment 522 and point cloud 524.

For example, given the initial vectorized polyline trajectory P=(p1, p2, . . . pM) (e.g., of polyline trajectory 306) and point clouds (P1, P2, . . . , PM) (e.g., of point cloud 302) in the trajectory frame, encoder 402 may first extract points from polyline trajectory P=(p1, p2, . . . pM) near each polyline segment pm by filtering points within a threshold distance from the polyline. For example, filter 506 may extract points of point cloud 504 that are near an example polyline segment 502.

Additionally, encoder 402 may perform polyline encoding. For example, encoder 402 may preprocess each polyline pm by smoothing and interpolating points to ensure consistent sampling. For example, smoother 508 may smooth and/or interpolate points of polyline segment 502.

Encoder 402 may encode each polyline segment pm=(x1, y1, x2, y2) using an encoder 510, where x1, y1, x2, y2 represent coordinate in space. Encoder 510 may be, or may include, a multilayer perceptron (MLP) configured to extract features aₘ=MLP(pm) ∈ RD. For example, encoder 510 may encode polyline segment 502 as polyline-segment features.

For example, in polyline preprocessing, encoder 402 may let the raw polyline be P=(p1, p2, . . . pM). Encoder 402 may uniformly resample the polyline to ensure consistent point spacing. Let the resampled polyline be

$${P}^{′} = ( {p}_{1}^{′} , {p}_{2}^{′} , … {p}_{N}^{′} )$$

where N is the number of points in the polyline.

To resample encoder 402 may use spline interpolation. For example, encoder 402 may fit a spline S(t) to the raw polyline P. Further, encoder 402 may uniformly sample time points t1, t2, . . . , tN. The resampled points are:

$${p}_{i}^{′} = S ( {t}_{i} )$$

where

$${p}_{i}^{′}$$

is the ith resampled point;
where S(t) is the spline interpolation function; and
where tᵢ is the ith uniformly sampled time point.

A spline S(t) is fit to the raw polyline points. For example, a polynomial equations is fit to the polyline points. Time points t1, t2, . . . , tN are uniformly sampled. Each resampled point

$${p}_{i}^{′}$$

is obtained by evaluating the spline at time tᵢ.

For each resampled segment p′m=(x1′, y1′, x2′, y2′) encoder 402 may extract features:

$${a}_{m} = MLP ( [ {x}_{1}^{′} ; {y}_{1}^{′} ; {x}_{2}^{′} ; {y}_{2}^{′} ; {x}_{2}^{′} - {x}_{1}^{′} ; {y}_{2}^{′} - {y}_{1}^{′} ] )$$

where aₘ is the encoded feature vector for polyline segment m;
where; is vector concatenation;
where MLP indicates the multi-layer perceptron function;
where

$$( [ {x}_{1}^{′} ; {y}_{1}^{′} ; {x}_{2}^{′} ; {y}_{2}^{′} ; {x}_{2}^{′} - {x}_{1}^{′} ; {y}_{2}^{′} - {y}_{1}^{′} ] )$$

is the input vector to the MLP;
where

$${x}_{1}^{′} and {y}_{1}^{′}$$

are the coordinates of the first point of segment m;
where

$${x}_{2}^{′} and {y}_{2}^{′}$$

are the coordinates of the second point;
where

$${x}_{2}^{′} - {x}_{1}^{′} , {y}_{2}^{′} - {y}_{1}^{′}$$

encode the segment length/direction; and
where MLP projects the 6D input to a D dimensional feature vector aₘ ∈ R\hat{ }D.

In this way, encoder 402 encodes each polyline segment (e.g., polyline segment 502 to polyline segment 522) as a fixed-size feature while preserving geometric properties like position and direction. The preprocessed polyline ensures consistent representation.

Additionally encoder 402 may encode point clouds (e.g., polyline segment 522 to point cloud 524). For example, given a point cloud Pi for each frame. Encoder 402 use a point cloud point-cloud encoder 512 (e.g., PointNet) to learn point-cloud features:

$$qi = PointNet ( Pi ) ∈ {RD}^{′}$$

Encoder 402 may align points to the polyline. In contrast, other methods may aggregate points globally. Encoder 402 may let P be the points near polyline segment i (by using a distance-based threshold), represented as a set of N points: Pi={p1, p2, . . . pN} Where each point pn is a 3D vector (xn,yn,zn).

Encoder 402 may voxelize points of point clouds into a 2D grid along the x-y plane. For example, voxelizer 514 may divide the x-y range into an M×N grid with bin width w and assign each point to the bin corresponding to its (x′, y′) coordinates. This gives a set of points Pi, m, n in each bin (m,n) for i=1 . . . M, j=1 . . . N.

Encoder 402 may perform point-feature extraction. For example, for points Pi, m, n in each bin, encoder 402 may extract per-point features using PointNet: qi,m, n=MLP(Pi, m, n) where qi, m, n is a D-dimensional feature representative of quantized features. Voxelizer 514 may be, or may include, an instance of PointNet, VoxelNet, or another suitable encoder.

Further, encoder 402 may encode the features. For example, encoder 402 may pass qi, m, n through a 2D CNN with filters [F1, F2, . . . ]:

$${f}_{i , j} = CNN ( [ {q}_{i - k , j - l} , … , {q}_{i , j} , … , {q}_{i + k , j + l} ] )$$

where f_{i,j} is the encoded feature at point (i,j);
where CNN represents the 2D convolutional neural network; and
where the input is a concatenation of point features within a local window in the 2D plane:
where q_{i-k,j_l} is the feature at point (i−k, j−l);
where q_{i,j} is the feature at point (i,j); and
where q_{{i+k,j+l}} is the feature at point (i+k, j+l).

Fusor 516 may fuse the polyline-segment features with related point-cloud features. Fusor 532 may fuse separate polyline segments using attention (e.g., self-attention or multi-head attention). For example, for each polyline segment i, fusor 532 may fuse the encoded polyline feature aᵢ and point cloud feature pᵢ to derive the final segment feature fᵢ:

$${f}_{i} = {a}_{i} + MLP ( {p}_{i} )$$

where aᵢ is the encoded feature for polyline segment i;
where pᵢ is the encoded point cloud feature for segment i (from 2D CNN);
where MLP maps pᵢ to the same dimension as aᵢ; and
where fᵢ is the fused feature for segment i. Fusor 516 may, among other things, determine how many coefficients to use to encode polyline segments.

Encoder 402 may apply the encoder independently to each segment to obtain: fᵢ_{_{1≤i≤M}} where M is the number of polyline segments.

Encoder 402 may fuse features per polyline segment rather than per frame. In this way, encoder 402 may encode both polyline geometry and point cloud context for each segment.

Additionally, fusor 516 may align the polyline-segment features with the point-cloud features. After fusing polyline-segment features with point-cloud features (e.g., at fusor 516), a fusor 532 of encoder 402 may fuse features from separate polyline segments using self-attention.

Returning to FIG. 4, after encoder 402 combines and encodes point cloud 302 and polyline segments 310 to generate combined features 404, transformer 406 may apply attention to combined features 404. Transformer 406 may perform multi-head attention.

At a high level, the input to the attention module is the feature sequence for each polyline segment (fᵢ, f₂, . . . , f_{M}), and the output is the updated segment features after cross-segment reasoning. The inputs are the features

$$( {g}_{1}^{( \{ ( L ) \} )} , … , {g}_{M}^{\{ ( L ) \}} )$$

encoded for each segment i. There are a total of M segments. The outputs are the updated features

$${g}_{i}^{\{ ( L ) \}}$$

for each segment i after passing through the attention block. L indicates it is the final output of L chained attention blocks. Attention blocks consume previous features:

$$( {g}_{1}^{( \{ ( j - 1 ) \} )} , … , {g}_{M}^{\{ ( j - 1 ) \}} ) \to ( {g}_{1}^{( \{ ( j ) \} )} , … , {g}_{M}^{\{ ( j ) \}} )$$

where the first block input is

$${g}_{i}^{\{ ( 0 ) \}} = {f}_{i} ;$$

where the attention block numbered j consumes the output features

$${g}_{i}^{\{ ( j - 1 ) \}}$$

from the previous block;
where the arrow indicates it produces the updated output features

$${g}_{i}^{\{ ( j ) \}} ;$$

and
where the superscripts (j−1) and j denote the previous and current block numbers.

For the first block, the input features

$${g}_{i}^{\{ ( 0 ) \}}$$

are set equal to the original input features fᵢ. Transformer 406 may perform pre-norm self-attention (or cross attention). For example, for each segment i feature gᵢ: transformer 406 may apply layer normalization:

$${h}_{i}^{′ ( j )} = LN ( {g}_{i}^{( j - 1 )} ) .$$

Transformer 406 may determine Linear Projections:

$${q}_{i}^{\{ ( j ) \}} , {k}_{i}^{\{ ( j ) \}} , {v}_{i}^{\{ ( j ) \}} ∈ {\{ R \}}^{D}$$

provide the queries, keys and values and stack keys, values into matrices:

$${K}_{i}^{\{ ( j ) \}} , {V}_{i}^{\{ ( j ) \}} ∈ {\{ R \}}^{\{ M \times D \}} .$$

For example, transformer 406 may determine attention scores between segment i and all segments:

$${a}_{i}^{\{ ( j ) \}} = softmax ( \frac{{q}_{i}^{\{ ( j ) \} {\{ {K}_{i}^{\{ ( j ) \}} \}}^{T}}}{\sqrt{\{ {d}_{k} \}}} + {W}_{i} ) ∈ {\{ R \}}^{M}$$

where

$${a}_{i}^{\{ ( j ) \}}$$

are the attention scores for segment i;
where softmax operates on the dot product of query

$${q}_{i}^{\{ \{ j ) \}}$$

and keys

$${K}_{i}^{{\{ ( j ) \}}^{T}} ;$$

where dₖ is a scaling factor for the dot product;
where wᵢ adds learned positional biases; and
where the scores are normalized using softmax to be in {R}^{M} and M is the total number of segments.

The aggregated features may be, or may include:

$${h}_{i}^{\{ ( j ) \}} = {a}_{i}^{\{ ( j ) \} {V}_{i}^{\{ ( j ) \}}}$$

The output features may be, or may include:

$${g}_{i}^{\{ ( j ) \}} = MLP ( LN ( {h}_{i}^{′ \{ ( j ) \}} + {h}_{i}^{\{ ( j ) \}} ) ) ∈ {\{ R \}}^{D}$$

where

$${h}_{i}^{\{ ( j ) \}}$$

is obtained by weighting values with attention scores;
where

$${g}_{i}^{\{ ( j ) \}}$$

applies MLP to the sum of

$${h}_{i}^{′ \{ ( j ) \}}$$

and aggregated feature

$${h}_{i}^{\{ ( j ) \}} ;$$

where LN denotes layer normalization;
where features are D-dimensional; and
superscript (j) indexes the attention block.

Transformer 406 may apply multi-head attention. There may be multiple (e.g., H) groups corresponding to multiple the multiple polyline segments. The features

$${\$g}_{i}^{\{ ( j - 1 ) \}} ∈ {\{ R \}}^{D}$$

are partitioned into H groups:

$${g}_{\{ i , 1 \}}^{\{ ( j - 1 ) \}} , … , {g}_{\{ i , H \}}^{\{ ( j - 1 ) \}} ∈ {\{ R \}}^{\{ \frac{D}{H} \}}$$

Separate projections are applied to each group. For head h:

$${g}_{\{ i , h \}}^{\{ ( j ) \}} , {k}_{\{ i , h \}}^{\{ ( j ) \}} , {v}_{\{ i , h \}}^{\{ ( j ) \}} = {W}_{h}^{Q} {g}_{\{ i , h \}}^{\{ ( j - 1 ) \}} , {W}_{h}^{K} {g}_{\{ i , h \}}^{\{ ( j - 1 ) \}} , {W}_{h}^{V} {g}_{\{ i , h \}}^{\{ ( j - 1 ) \}}$$

where

$${W}_{h}^{Q} , {W}_{h}^{K} , {W}_{h}^{V} ∈ {\{ R \}}^{\{ \frac{D}{H} \times \frac{D}{H} \}}$$

are learnable projection matrices.

Attention is computed independently for each head h:

$${a}_{\{ i , h \}}^{\{ ( j ) \}} = softmax ( \frac{{q}_{\{ i , h \}}^{\{ ( j ) \} {\{ {k}_{\{ i , h \}}^{\{ ( j ) \}} \}}^{T}}}{\sqrt{\{ \frac{D}{H} \}}} )$$

Features are aggregated as:

$${h}_{\{ i , h \}}^{j} = {a}_{\{ i , h \}}^{j} {v}_{\{ i , h \}}^{j} .$$

Outputs from all heads are concatenated:

$${h}_{i}^{\{ ( j ) \}} = concat ( {h}_{\{ i , 1 \}}^{\{ ( j ) \}} , … , {h}_{\{ i , H \}}^{\{ ( j ) \}} ) ∈ {\{ R \}}^{D} .$$

The final outputs of transformer 406 may be features 408. System 400 may store features 408 in memory 410.

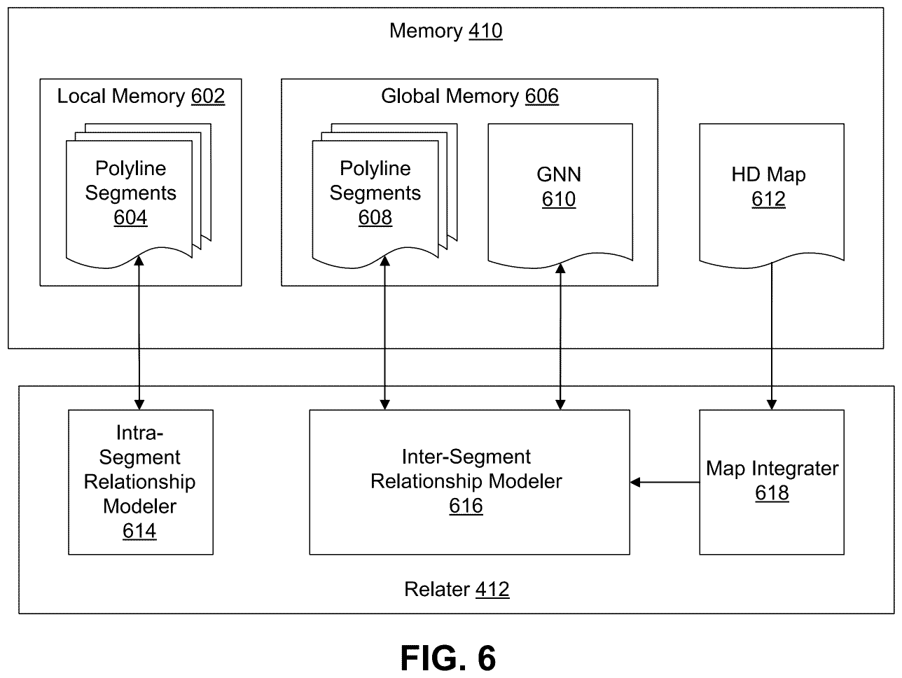

FIG. 6 is a block diagram to provide additional detail regarding memory 410 and relater 412 of FIG. 4, according to various aspects of the present disclosure. Memory 410 may include a local memory 602 and a global memory 606. In general, local memory 602 may store polyline segments 604 that are based on one frame (e.g., one instance of point cloud 302 and/or polyline segments 310). Additionally, global memory 606 may store polyline segments 608 that are based on multiple frames (e.g., multiple previously-received instances of point cloud 302 and/or polyline segments 310).

Intra-segment relationship modeler 614 may relate points of polyline segments of the same polyline. For example, when a new polyline segment is received, intra-segment relationship modeler 614 may relate the newly-received polyline segment to a corresponding previously-received polyline segment (as stored in local memory 602). Intra-segment relationship modeler 614 may then smooth points of the newly-received polyline segment based, at least in part on the previously-received corresponding polyline segment.

Intra-segment relationship modeler 614 may analyze and represent relationships within individual segment of a polyline, for improving the accuracy and robustness of polyline estimations in tasks like computer vision, mapping, or 3D reconstruction.

In polyline-estimation tasks, accurately predicting and representing the shape and structure of objects or boundaries may be important. Polyline estimation involves generating a sequence of connected line segments that approximate a target shape, such as the outline of an object in an image or a path in a mapping application. In this context, “intra-segment relationship modeling” refers to the detailed analysis and representation of the characteristics and internal dynamics of each individual segment within the polyline.

Some aspects of Intra-Segment Modeling in Polylines Estimation include segment length consistency, directionality and orientation, curvature approximation, sub-segment division for refinement, error reduction and smoothing, and feature sensitivity.

In many estimation tasks, maintaining a consistent length across segments within a polyline may be important for accuracy. Intra-segment modeling involves analyzing how segment lengths should be adjusted or maintained based on the underlying data. For instance, in an object boundary estimation task, if the boundary changes sharply, the segment length might need to be reduced to capture the detail accurately.

The direction and orientation of each segment may be important for estimation tasks. Intra-segment modeling includes calculations of the angle at which a segment is oriented relative to the preceding segment, ensuring that the overall shape of the polyline follows the target shape or boundary. This aspect may be important for tasks like road or pathway estimation, where the direction should follow the actual path closely.

Although a polyline is typically composed of straight-line segments, many shapes and boundaries in real-world data are curved. Intra-segment modeling includes techniques for approximating curvature within a single segment. This may involve using a series of closely connected small segments that together approximate a curve or employing mathematical functions to adjust the segment's orientation progressively to simulate curvature.

For high-precision tasks, segments may be internally divided into sub-segments. These sub-segments may be used to refine the polyline by capturing finer details of the target shape. Intra-segment modeling manages the relationships between these sub-segments, ensuring that they collectively represent the intended detail without distorting the overall polyline structure.

In estimation tasks, reducing error between the estimated polyline and the actual target shape may be important. Intra-segment modeling involves techniques for adjusting each segment to reduce this error, such as through optimization algorithms that tweak the segment's position, length, and/or angle. Additionally, smoothing techniques may be applied within segments to cause transitions between segments to be seamless so the polyline appears continuous.

Segments may need to be sensitive to specific features in the data, such as edges, corners, or gradients in an image. Intra-segment modeling may involve calibrating each segment's response to these features, ensuring that the polyline accurately follows the critical features of the target shape. For instance, in edge-detection tasks, segments would be adjusted to align closely with detected edges in the image.

The intra-segment relationships may be represented mathematically, using parametric equations or optimization functions that define the segment's position, length, and orientation in relation to the data being modeled.

Algorithms may be employed to adjust each segment dynamically based on the underlying data (e.g., image pixels, map coordinates). This causes polyline to remain an accurate and robust representation of the target shape.

Since each segment in a polyline is connected to the next, intra-segment modeling may also involve causing adjustments to one segment to not disrupt the overall continuity and accuracy of the polyline. This might involve processing segments sequentially and making fine-tuned adjustments iteratively.

In contrast to intra-segment relationship modeler 614 which may relate points of polyline segments of the same polyline, inter-segment relationship modeler 616 may relate points of polyline segments with polyline segments of other polylines. For example, inter-segment relationship modeler 616 may relate points of a left lane boundary to points of a right line boundary. Inter-segment relationship modeler 616 may apply attention to relate the points.

Local memory 602 may store information about previously-received segments of each polyline (e.g., polyline segments 604). By retaining a local memory of previously-received polyline segments 604, intra-segment relationship modeler 614 of relater 412 can smooth out the trajectory locally, ensuring that each segment aligns smoothly with its neighboring segments. Local memory 602 enables intra-segment relationship modeler 614 to refine the polyline trajectory based on immediate context and known variables such as angles followed during turns. This refinement process helps in maintaining geometric consistency and smoothness within each segment.

Global memory 606, on the other hand, may operate at a broader scale. Inter-segment relationship modeler 616 leverages a Graph Neural Network (GNN) 610 to capture relationships between different polyline segments (e.g., polyline segments 608) stored in global memory 606. Inter-segment relationship modeler 616 can also take into account additional information from an HD map 612, which provides context about the surrounding environment. By utilizing GNN 610, inter-segment relationship modeler 616 can perform more sophisticated reasoning about the entire polyline trajectory, considering inter-segment dependencies and optimizing the polyline as a whole.

This allows for global smoothing of the trajectory, ensuring that the polyline remains coherent and accurate across its entire length. Having separate local and global memory modules (e.g., local memory 602 and global memory 606) allows relater 412 to address polyline estimation challenges at different scales. Intra-segment relationship modeler 614 uses polyline segments 604 stored in local memory 602 to focus on fine-tuning individual segments, while inter-segment relationship modeler 616 uses polyline segments 608 stored in global memory 606 to considers the overall structure of the polyline and how segments relate to each other. By combining polyline segments 604 and polyline segments 608 stored in local memory 602 and global memory 606 respectively, intra-segment relationship modeler 614 and inter-segment relationship modeler 616 of relater 412 can produce polyline predictions with improved geometric consistency, smoothness, and overall accuracy.

Within the global memory 606, GNN 610 may be employed to capture complex relationships and dependencies between polyline segments 608. GNN 610 may operate on a graph representation of polyline segments 608, where segments are nodes, and connections between segments are edges. Each segment node is associated with its features, which are updated iteratively through message passing between neighboring nodes. GNN 610 aggregates information from neighboring segments to refine segment features based on their contextual relationships within the polyline. By leveraging GNN 610, inter-segment relationship modeler 616 can capture global dependencies and optimize the entire polyline trajectory cohesively. Inter-segment relationship modeler 616 may, using GNN 610, perform graph-based attention analysis of polyline segments 608.

HD map 612 may be, or may include, HD map information. HD map 612 may be integrated into global memory 606 to provide additional contextual information about the surrounding environment. HD map 612 may include detailed data about road networks, lane markings, traffic signs, and other relevant infrastructure. This information can be encoded as additional features and concatenated with segment features before inputting into the attention mechanism (e.g., of transformer 406) or GNN 610. By incorporating HD map 612, system 400 gains a better understanding of the road topology and can make more informed decisions during polyline refinement. HD map 612 features can guide the attention mechanism (e.g., of transformer 406) or influence message passing in GNN 610, enhancing the overall accuracy and robustness of the polyline estimation process. In some aspects, HD map 612 may be cross-checked with predictions of system 400. Additionally or alternatively, during training of system 400, HD map 612 may be used to determine losses for training models of system 400.

Returning to FIG. 4, decoder 414 may decode the output features for each polyline segment. The final outputs may be:

$${g}_{1}^{\{ ( L ) \}} , … , {g}_{M}^{\{ ( L ) \}} ,$$

where

$${g}_{i}^{\{ ( L ) \}}$$

are the final output features for each segment i. L indicates these are the outputs after L attention blocks. There are a total of M segments. The outputs form a sequence of updated features for each segment i.

Decoder 414 may predict refined coordinates for each segment endpoint, predict connections between segments to form the full polyline. For each segment i with original endpoints: (x_{{i1}}, y_{{i1}}), (x_{{i2}},y_{{i2}}).

The decoder predicts:

$$( Δ {x}_{\{ i 1 \}} , Δ {y}_{\{ i 1 \}} ) ( Δ {x}_{\{ i 2 \}} , Δ {y}_{\{ i 2 \}} )$$

where Δx, Δy are residual offsets to refine the coordinates. The final refined coordinates are:

$$\begin{matrix}\{ {\hat{x}}_{\{ i 1 \}} , {\hat{y}}_{\{ i 1 \}} ) = ( {x}_{\{ i 1 \}} + Δ {x}_{\{ i 1 \}} , {y}_{\{ i 1 \}} + Δ {y}_{\{ i 1 \}} ) \\ \{ {\hat{x}}_{\{ i 2 \}} , {\hat{y}}_{\{ i 2 \}} ) = ( {x}_{\{ i 2 \}} + Δ {x}_{\{ i 2 \}} , {y}_{\{ i 2 \}} + Δ {y}_{\{ i 2 \}} )\end{matrix}$$

where {\hat{x}_{{i1}},ŷ_{{i1}}) are the refined coordinates; and
where Δx_{{i1}},y_{{i1}} are the predicted offsets.

Decoder 414 may smooth predictions. The offsets describe how points are positioned to make smooth the outputs. Further, decoder 414 may determine the second the second endpoint in a similar fashion.

Smoothing features (which may be performed by decoder 414 based on inputs from intra-segment relationship modeler 614 and/or inter-segment relationship modeler 616), especially in the context of polyline segments, may involve adjusting or refining the characteristics of the polyline to remove irregularities, reduce noise, and create a more consistent and continuous representation of the underlying shape or data. Techniques for smoothing features that may be implemented by smoother 508 include averaging techniques (e.g., point averaging and weighted averaging), spline interpolation (e.g., b-splines and cubic splines), Bezier curves, filtering techniques (e.g., low-pass filtering and Gaussian filtering), gradient-descent optimization, and constraint-based smoothing (e.g., boundary-constrained smoothing and feature-preserving smoothing).

Point averaging involves calculating the average position of neighboring points within a polyline segment. The position of each point can be updated based on the average of its immediate neighbors, which helps to eliminate sharp angles and creates a smoother transition between points.

In weighted averaging, points are adjusted based on a weighted average, where closer points have more influence on the final position. This technique allows for more control over the degree of smoothing, with weights determining how much the smoothing affects each point.

Smoothing can be achieved by fitting spline curves (e.g., b-splines or cubic splines) through the points of the polyline segment. Splines are mathematical functions that provide a smooth that passes through or near the points of the segment, reducing abrupt changes and creating a continuous, smooth representation.

Another approach is to use Bezier curves, which are defined by control points that influence the shape of the curve. Adjusting these control points allows for smoothing the polyline segment while maintaining control over the curve's tension and continuity.

Low-Pass Filtering involves applying a low-pass filter to the points of the polyline segment, which smooths out high-frequency noise while preserving the overall shape. The filter reduces the impact of sudden changes or outliers in the data, resulting in a smoother segment.

Gaussian filters apply a weighted average based on a Gaussian distribution, smoothing the polyline by averaging points in a manner that gives more weight to closer neighbors. This creates a natural, smooth curve without significant distortion of the polyline's original shape.

Smoothing can also be achieved by optimizing the polyline segment to minimize abrupt changes in direction or distance between points. This can be done using gradient descent techniques, where the polyline is iteratively adjusted to reduce a cost function that penalizes sharp angles or irregular distances between points.

Smoothing can be constrained by certain conditions, such as preserving the endpoints or maintaining a fixed distance between points. This method allows for smoothing while ensuring that the polyline adheres to specific constraints or conditions imposed by the application.

Feature-preserving smoothing involves smoothing the polyline while preserving important features, such as corners or significant bends. Techniques like anisotropic smoothing selectively smooth parts of the polyline while keeping sharp features intact.

Decoder 414 may decode features related by intra-segment relationship modeler 614 and/or inter-segment relationship modeler 616 to generate refined polyline segments 416. Decoder 414 may perform endpoint refinement and segment connection (e.g., refining the end points of segments and determining connections between segments). Decoder 414 may predict a binary variable ci, i+1 for each pair of segments (i, i+1): ci, i+1=1 if segments are connected and 0 if the segments are not connected. The binary variable may indicate whether the endpoint of segment i is connected to the start point of segment i+1 to form the full polyline trajectory. Together, predicting refined endpoints and connections allows reconstructing the optimal vectorized polyline trajectory.

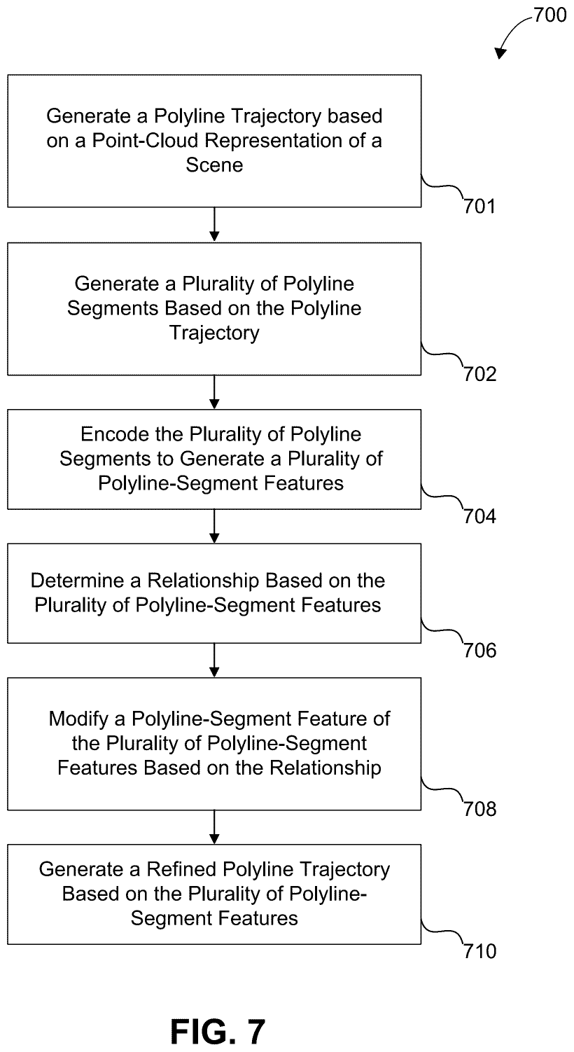

FIG. 7 is a flow diagram illustrating an example process 700 for polyline estimation, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 700. The one or more operations of process 700 may be implemented as software components that are executed and run on one or more processors.

At block 701, a computing device (or one or more components thereof) may generate a polyline trajectory based on a point-cloud representation of a scene. For example, polyline generator 304 may generate polyline trajectory 306 based on point cloud 302.

At block 702, the computing device (or one or more components thereof) may generate a plurality of polyline segments based on the polyline trajectory. For example, polyline segmenter 308 may generate polyline segments 310 based on Polyline trajectory 306.

In some aspects, the computing device (or one or more components thereof) may resample each polyline segment of the plurality of polyline segments prior to processing the plurality of polyline segments. For example, encoder 402 may resample polyline segments 310. In some aspects, the computing device (or one or more components thereof) may resample each polyline segment using spline interpolation.

At block 704, the computing device (or one or more components thereof) may process the plurality of polyline segments to generate a plurality of polyline-segment features. For example, encoder 402 may process polyline segments 310 to generate a plurality of polyline-segment features.

In some aspects, encode the plurality of polyline segments using a multi-layer perceptron (MLP). For example, encoder 402 may be, or may include, an MLP. For example, encoder 510 may be, or may include, an MLP.

At block 706, the computing device (or one or more components thereof) may determine a relationship associated with polylines of the polyline trajectory based on the plurality of polyline-segment features. For example, relater 412 may determine a relationship associated with polylines of polyline trajectory 306 based on the plurality of polyline-segment features.

In some aspects, the computing device (or one or more components thereof) may determine the relationship using an attention mechanism. For example, relater 412 may implement a transformer machine-learning model that implements attention to determine the relationship.

In some aspects, the relationship may be, or may include, a relationship between points of a polyline segment of the plurality of polyline segments. To update the polyline-segment feature, the computing device (or one or more components thereof) may smooth the polyline-segment feature of the plurality of polyline-segment features based on the points of the polyline segment. For example, the relationship determined at block 706 may be, or may include, an intra-segment relationship. For example, intra-segment relationship modeler 614 may identify the relationship. Additionally or alternatively, decoder 414 may smooth polyline segments 604 based on the intra-segment relationship determined by intra-segment relationship modeler 614.

In some aspects, the computing device (or one or more components thereof) may smooth the polyline-segment feature based on a turn angle.

In some aspects, the computing device (or one or more components thereof) may process the point-cloud representation of the scene to generate a plurality of point-cloud features; and combine at least one polyline-segment feature of the plurality of polyline-segment features with at least one point-cloud feature of the plurality of point-cloud features to generate at least one combined feature. The computing device (or one or more components thereof) may determine the relationship based on the at least one combined feature. For example, point cloud point-cloud encoder 512 may process point cloud 504 to generate point-cloud features. Additionally, encoder 510 may process polyline segment 502 to generate polyline-segment features. Fusor 516 may combine the point-cloud features with the polyline-segment features to generate combined features. Relater 412 may determine the relationship (at block 706) based on the combined features.

In some aspects, the computing device (or one or more components thereof) may process the plurality of polyline segments to generate the plurality of polyline-segment features using a machine-learning-model encoder. For example, encoder 510 may be, or may include, an encoder and may process polyline segment 502 to generate the polyline-segment features.

In some aspects, the computing device (or one or more components thereof) may process the point-cloud representation to generate a plurality of voxels prior to combining the at least one polyline-segment feature with the at least one point-cloud feature. For example, voxelizer 514 may process point cloud 504 or the point-cloud features generated by point cloud point-cloud encoder 512 based on point cloud 504 to generate voxels. Fusor 516 may combine the voxels with the polyline-segment features.

In some aspects, the relationship comprises a relationship between a polyline segment of the plurality of polyline segments and another polyline segment of the plurality of polyline segments. To update the polyline-segment feature, the computing device (or one or more components thereof) may smooth the polyline-segment feature of the plurality of polyline segments based on the other polyline segment. For example, the relationship determined at block 706 may be, or may include, an inter-segment relationship. For example, inter-segment relationship modeler 616 may identify the relationship. Additionally or alternatively, decoder 414 may smooth polyline segments 608 based on the inter-segment relationships determined by inter-segment relationship modeler 616.

In some aspects, the computing device (or one or more components thereof) may to smooth the polyline-segment feature based on a graph neural network (GNN), wherein the GNN is based on the plurality of polyline segments. For example, decoder 414 may smooth polyline-segment features based on a GNN. The GNN may be based on polyline trajectory 306.

At block 708, the computing device (or one or more components thereof) may update a polyline-segment feature of the plurality of polyline-segment features based on the relationship. For example, relater 412 may update a polyline-segment feature based on the relationship determined at block 706.

At block 710, the computing device (or one or more components thereof) may process the plurality of polyline-segment features to generate a refined polyline trajectory. For example, decoder 414 may decode the plurality of polyline-segment features to generate refined polyline segments 416.

In some aspects, the computing device (or one or more components thereof) may process the plurality of polyline-segment features to generate a refined polyline trajectory using a machine-learning-model decoder. For example, decoder 414 may process the polyline-segment features to generate refined polyline segments 416.

In some aspects, the computing device (or one or more components thereof) may be a computing device of a vehicle. In some aspects, the computing device (or one or more components thereof) may adjust an operating parameter of the vehicle based on the refined polyline trajectory. In some aspects, the operating parameter may be associated with at least one of a path for the vehicle to travel, an automatic-braking parameter for operating one or more brakes of the vehicle, a lane-change parameter for causing the vehicle to navigate from a first lane to a second lane, or displaying information using a user interface of the vehicle.

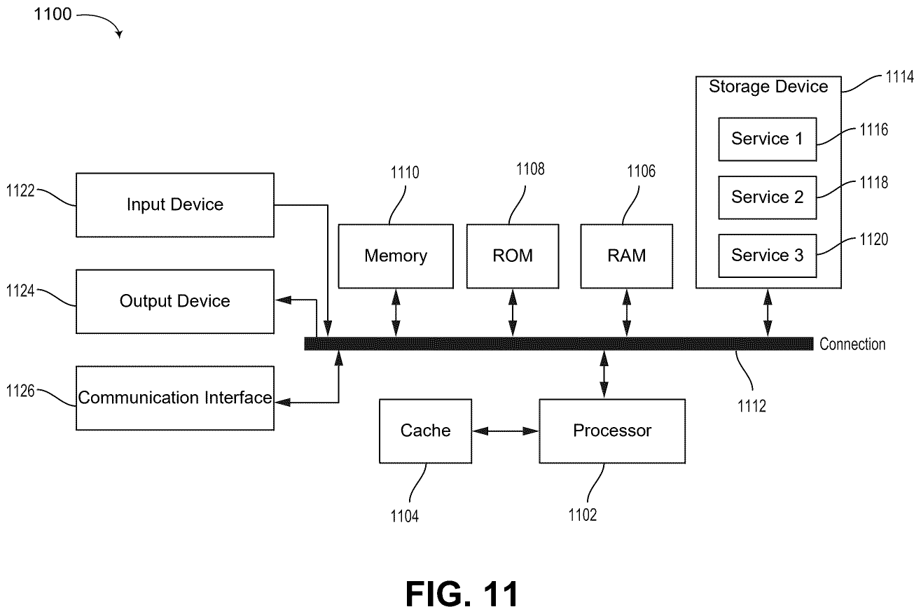

In some examples, as noted previously, the methods described herein (e.g., process 700 of FIG. 7, and/or other methods described herein) can be performed, in whole or in part, by a computing device or apparatus. In one example, one or more of the methods can be performed by system 400 of FIG. 4, or by another system or device. In another example, one or more of the methods (e.g., process 700, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 400 and can implement the operations of process 700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

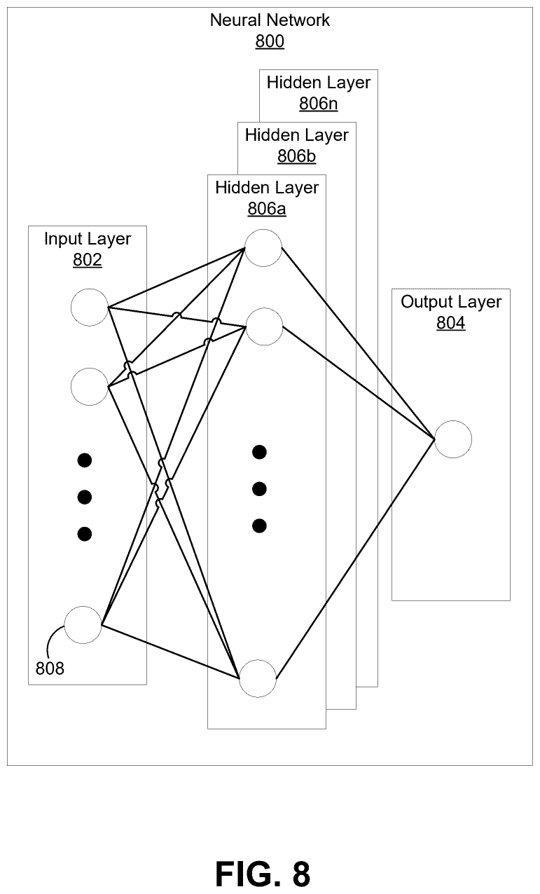

FIG. 8 is an illustrative example of a neural network 800 (e.g., a deep-learning neural network) that can be used to implement machine-learning based polyline generation, polyline segmentation, point-cloud encoding, polyline-segment encoding, decoding, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 800 may be an example of, or can implement, ___

An input layer 802 includes input data. In one illustrative example, input layer 802 can include data representing point cloud 302 of FIG. 3 and FIG. 4, polyline segments 310 of FIG. 3, and FIG. 4, polyline segment 502 of FIG. 5, point cloud 504 of FIG. 5, polyline segment 522 of FIG. 5, point cloud 524 of FIG. 5. Neural network 800 includes multiple hidden layers, for example, hidden layers 806a, 806b, through 806n. The hidden layers 806a, 806b, through hidden layer 806n include “n” number of hidden layers, where “n” is an integer greater than or equal to one. The number of hidden layers can be made to include as many layers as needed for the given application. Neural network 800 further includes an output layer 804 that provides an output resulting from the processing performed by the hidden layers 806a, 806b, through 806n. In one illustrative example, output layer 804 can provide features (e.g., polyline-segment features, point-cloud features, and/or combined features), and/or polyline segments, such as refined polyline segments 416 of FIG. 4.

Neural network 800 may be, or may include, a multi-layer neural network of interconnected nodes. Each node can represent a piece of information. Information associated with the nodes is shared among the different layers and each layer retains information as information is processed. In some cases, neural network 800 can include a feed-forward network, in which case there are no feedback connections where outputs of the network are fed back into itself. In some cases, neural network 800 can include a recurrent neural network, which can have loops that allow information to be carried across nodes while reading in input.

Information can be exchanged between nodes through node-to-node interconnections between the various layers. Nodes of input layer 802 can activate a set of nodes in the first hidden layer 806a. For example, as shown, each of the input nodes of input layer 802 is connected to each of the nodes of the first hidden layer 806a. The nodes of first hidden layer 806a can transform the information of each input node by applying activation functions to the input node information. The information derived from the transformation can then be passed to and can activate the nodes of the next hidden layer 806b, which can perform their own designated functions. Example functions include convolutional, up-sampling, data transformation, and/or any other suitable functions. The output of the hidden layer 806b can then activate nodes of the next hidden layer, and so on. The output of the last hidden layer 806n can activate one or more nodes of the output layer 804, at which an output is provided. In some cases, while nodes (e.g., node 808) in neural network 800 are shown as having multiple output lines, a node has a single output and all lines shown as being output from a node represent the same output value.

In some cases, each node or interconnection between nodes can have a weight that is a set of parameters derived from the training of neural network 800. Once neural network 800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 800 to be adaptive to inputs and able to learn as more and more data is processed.

Neural network 800 may be pre-trained to process the features from the data in the input layer 802 using the different hidden layers 806a, 806b, through 806n in order to provide the output through the output layer 804. In an example in which neural network 800 is used to identify features in images, neural network 800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 800 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 800 is trained well enough so that the weights of the layers are accurately tuned.

For the example of identifying objects in images, the forward pass can include passing a training image through neural network 800. The weights are initially randomized before neural network 800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as E_{totaL}=Σ_{1/2} (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and f denotes a learning rate. The learning rate can be set to any suitable value, with a high learning rate including larger weight updates and a lower value indicating smaller weight updates.

Neural network 800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 800 can include any other deep network other than a CNN, such as an autoencoder, a deep belief nets (DBNs), a Recurrent Neural Networks (RNNs), among others.

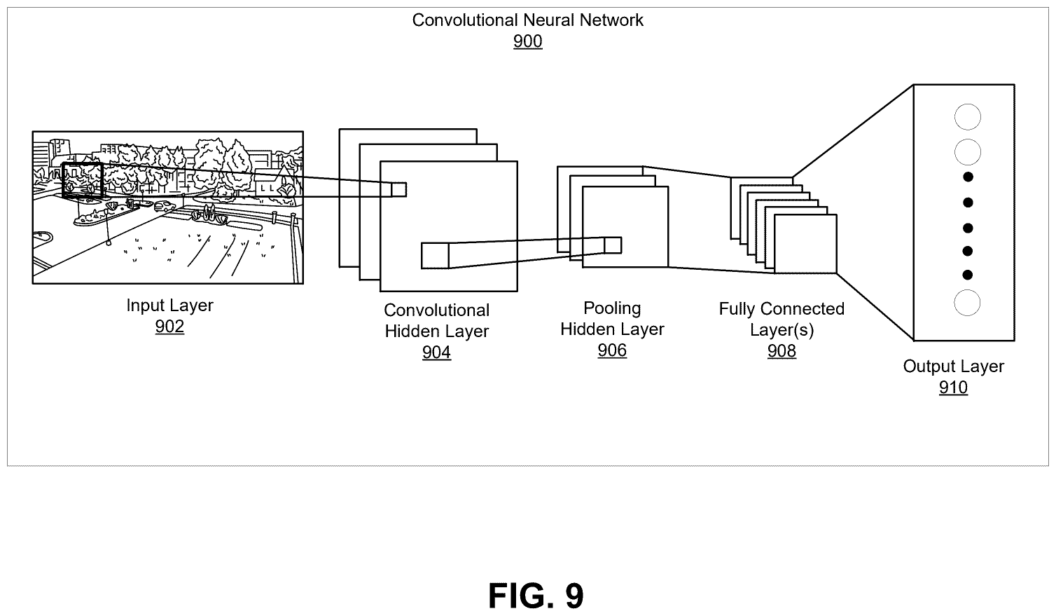

FIG. 9 is an illustrative example of a convolutional neural network (CNN) 900. The input layer 902 of the CNN 900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 904, an optional non-linear activation layer, a pooling hidden layer 906, and fully connected layer 908 (which fully connected layer 908 can be hidden) to get an output at the output layer 910. While only one of each hidden layer is shown in FIG. 9, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 can be the convolutional hidden layer 904. The convolutional hidden layer 904 can analyze image data of the input layer 902. Each node of the convolutional hidden layer 904 is connected to a region of nodes (pixels) of the input image called a receptive field. The convolutional hidden layer 904 can be considered as one or more filters (each filter corresponding to a different activation or feature map), with each convolutional iteration of a filter being a node or neuron of the convolutional hidden layer 904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 904. Each connection between a node and a receptive field for that node learns a weight and, in some cases, an overall bias such that each node learns to analyze its particular local receptive field in the input image. Each node of the convolutional hidden layer 904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 904 is due to each node of the convolutional layer being applied to its corresponding receptive field. For example, a filter of the convolutional hidden layer 904 can begin in the top-left corner of the input image array and can convolve around the input image. As noted above, each convolutional iteration of the filter can be considered a node or neuron of the convolutional hidden layer 904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 904.

The mapping from the input layer to the convolutional hidden layer 904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 904 can include several activation maps in order to identify multiple features in an image. The example shown in FIG. 9 includes three activation maps. Using three activation maps, the convolutional hidden layer 904 can detect three different kinds of features, with each feature being detectable across the entire image.

In some examples, a non-linear hidden layer can be applied after the convolutional hidden layer 904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 900 without affecting the receptive fields of the convolutional hidden layer 904.

The pooling hidden layer 906 can be applied after the convolutional hidden layer 904 (and after the non-linear hidden layer when used). The pooling hidden layer 906 is used to simplify the information in the output from the convolutional hidden layer 904. For example, the pooling hidden layer 906 can take each activation map output from the convolutional hidden layer 904 and generates a condensed activation map (or feature map) using a pooling function. Max-pooling is one example of a function performed by a pooling hidden layer. Other forms of pooling functions be used by the pooling hidden layer 906, such as average pooling, L2-norm pooling, or other suitable pooling functions. A pooling function (e.g., a max-pooling filter, an L2-norm filter, or other suitable pooling filter) is applied to each activation map included in the convolutional hidden layer 904. In the example shown in FIG. 9, three pooling filters are used for the three activation maps in the convolutional hidden layer 904.

In some examples, max-pooling can be used by applying a max-pooling filter (e.g., having a size of 2×2) with a stride (e.g., equal to a dimension of the filter, such as a stride of 2) to an activation map output from the convolutional hidden layer 904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 904 having a dimension of 24×24 nodes, the output from the pooling hidden layer 906 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 906 to every one of the output nodes in the output layer 910. Using the example above, the input layer includes 28×28 nodes encoding the pixel intensities of the input image, the convolutional hidden layer 904 includes 3×24×24 hidden feature nodes based on application of a 5×5 local receptive field (for the filters) to three activation maps, and the pooling hidden layer 906 includes a layer of 3×12×12 hidden feature nodes based on application of max-pooling filter to 2×2 regions across each of the three feature maps. Extending this example, the output layer 910 can include ten output nodes. In such an example, every node of the 3×12×12 pooling hidden layer 906 is connected to every node of the output layer 910.

The fully connected layer 908 can obtain the output of the previous pooling hidden layer 906 (which should represent the activation maps of high-level features) and determines the features that most correlate to a particular class. For example, the fully connected layer 908 can determine the high-level features that most strongly correlate to a particular class and can include weights (nodes) for the high-level features. A product can be computed between the weights of the fully connected layer 908 and the pooling hidden layer 906 to obtain probabilities for the different classes. For example, if the CNN 900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 910 can include an M-dimensional vector (in the prior example, M=10). M indicates the number of classes that the CNN 900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

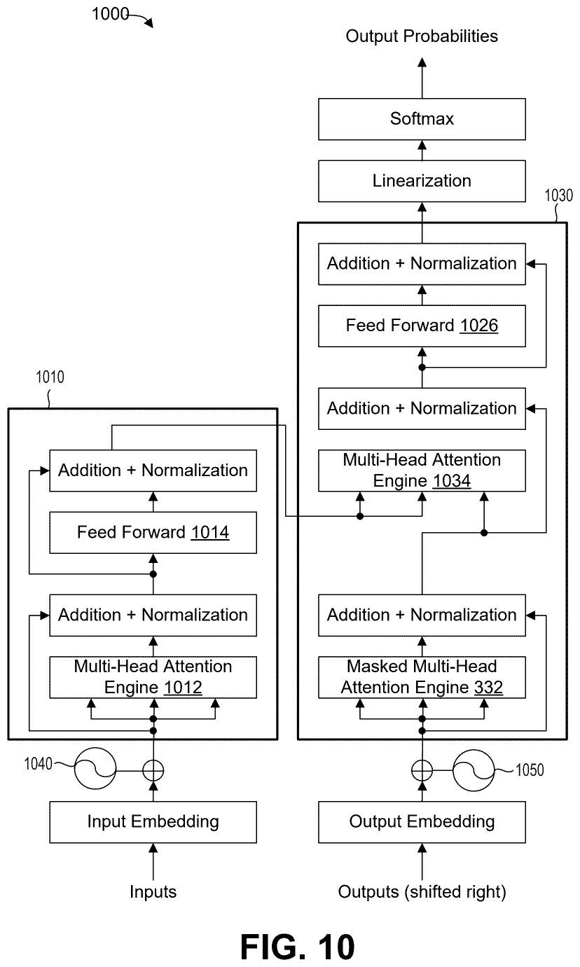

FIG. 10 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1000 reduces the operations of learning dependencies by using an encoder 1010 and a decoder 1030 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1010 is composed of a stack of six identical layers and each layer has two sub-layers. The first sub-layer is a multi-head self-attention engine 1012, and the second sub-layer is a fully-connected feed-forward network 1014. A residual connection (not shown) connects around each of the sub-layers followed by normalization.

In this example transformer 1000, the decoder 1030 is also composed of a stack of six 6 identical layers. The decoder also includes a masked multi-head self-attention engine 1032, a multi-head attention engine 1034 over the output of the encoder 1010, and a fully-connected feed-forward network 1026. Each layer includes a residual connection (not shown) around the layer, which is followed by layer normalization. The masked multi-head self-attention engine 1032 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1040 to encode positions because the model does not contain recurrence and convolution and relative or absolute position of the tokens is needed. In the transformer 1000, the positional encodings are added to the input embeddings at the bottom layer of the encoder 1010 and the decoder 1030. The positional encodings are summed with the embeddings because the positional encodings and embeddings have the same dimensions. A corresponding position decoder 1050 is configured to decode the positions of the embeddings for the decoder 1030.

In some aspects, the transformer 1000 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1000 can process input sequences of variable length, making it well-suited for natural language processing tasks where input lengths can vary greatly. Additionally, the self-attention mechanism allows the transformer 1000 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 300 of FIG. 3, system 400 of FIG. 4, encoder 402 of FIG. 4 and FIG. 5, memory 410 of FIG. 4 and FIG. 6, relater 412 of FIG. 4 and FIG. 6 and/or other devices, modules, or systems described herein. Additionally or alternatively, computing-device architecture 1100 may be configured to perform process 700, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for refining polylines, the apparatus comprising: at least one memory; and at least one processor coupled to the at least one memory and configured to: generate a polyline trajectory based on a point-cloud representation of a scene; generate a plurality of polyline segments based on the polyline trajectory; process the plurality of polyline segments to generate a plurality of polyline-segment features; determine a relationship associated with polylines of the polyline trajectory based on the plurality of polyline-segment features; update a polyline-segment feature of the plurality of polyline-segment features based on the relationship; and process the plurality of polyline-segment features to generate a refined polyline trajectory.
Aspect 2. The apparatus of aspect 1, wherein the at least one processor is configured to generate the polyline trajectory based on the point-cloud representation of the scene.
Aspect 3. The apparatus of any one of aspects 1 or 2, wherein the at least one processor is configured to resample each polyline segment of the plurality of polyline segments prior to processing the plurality of polyline segments.
Aspect 4. The apparatus of aspect 3, wherein the at least one processor is configured to resample each polyline segment using spline interpolation.
Aspect 5. The apparatus of any one of aspects 1 to 4, wherein the at least one processor is configured to encode the plurality of polyline segments using a multi-layer perceptron (MLP).
Aspect 6. The apparatus of any one of aspects 1 to 5, wherein: the relationship comprises a relationship between points of a polyline segment of the plurality of polyline segments; and to update the polyline-segment feature, the at least one processor is configured to smooth the polyline-segment feature of the plurality of polyline-segment features based on the points of the polyline segment.
Aspect 7. The apparatus of aspect 6, wherein the at least one processor is configured to smooth the polyline-segment feature based on a turn angle.
Aspect 8. The apparatus of any one of aspects 1 to 7, wherein: the relationship comprises a relationship between a polyline segment of the plurality of polyline segments and another polyline segment of the plurality of polyline segments; and to update the polyline-segment feature, the at least one processor is configured to smooth the polyline-segment feature of the plurality of polyline segments based on the other polyline segment.
Aspect 9. The apparatus of aspect 8, wherein the at least one processor is configured to smooth the polyline-segment feature based on a graph neural network (GNN), wherein the GNN is based on the plurality of polyline segments.
Aspect 10. The apparatus of any one of aspects 1 to 9, wherein the at least one processor is configured to determine the relationship using an attention mechanism.
Aspect 11. The apparatus of any one of aspects 1 to 10, at least one processor coupled to the at least one memory and configured to:: process the point-cloud representation of the scene to generate a plurality of point-cloud features; and combine at least one polyline-segment feature of the plurality of polyline-segment features with at least one point-cloud feature of the plurality of point-cloud features to generate at least one combined feature; wherein the at least one processor is configured to determine the relationship based on the at least one combined feature.
Aspect 12. The apparatus of aspect 11, wherein the at least one processor is configured to process the point-cloud representation to generate a plurality of voxels prior to combining the at least one polyline-segment feature with the at least one point-cloud feature.
Aspect 13. The apparatus of any one of aspects 1 to 12, wherein the at least one processor is configured to process the plurality of polyline segments to generate the plurality of polyline-segment features using a machine-learning-model encoder.
Aspect 14. The apparatus of any one of aspects 1 to 13, wherein the at least one processor is configured to process the plurality of polyline-segment features to generate a refined polyline trajectory using a machine-learning-model decoder.
Aspect 15. A method for refining polylines, the method comprising: generating a polyline trajectory based on a point-cloud representation of a scene; generating a plurality of polyline segments based on the polyline trajectory; processing the plurality of polyline segments to generate a plurality of polyline-segment features; determining a relationship associated with polylines of the polyline trajectory based on the plurality of polyline-segment features; updating a polyline-segment feature of the plurality of polyline-segment features based on the relationship; and processing the plurality of polyline-segment features to generate a refined polyline trajectory.
Aspect 16. The method of aspect 15, further comprising generating the polyline trajectory based on the point-cloud representation of the scene.
Aspect 17. The method of any one of aspects 15 or 16, further comprising resampling each polyline segment of the plurality of polyline segments prior to processing the plurality of polyline segments.
Aspect 18. The method of aspect 17, wherein each polyline segment is resampled using spline interpolation.
Aspect 19. The method of any one of aspects 15 to 18, wherein the plurality of polyline segments are encoded using a multi-layer perceptron (MLP).
Aspect 20. The method of any one of aspects 15 to 19, wherein: the relationship comprises a relationship between points of a polyline segment of the plurality of polyline segments; and updating the polyline-segment feature comprises smoothing the polyline-segment feature of the plurality of polyline-segment features based on the points of the polyline segment.
Aspect 21. The method of aspect 20, wherein the polyline-segment feature are smoothed based on a turn angle.
Aspect 22. The method of any one of aspects 15 to 21, wherein: the relationship comprises a relationship between a polyline segment of the plurality of polyline segments and another polyline segment of the plurality of polyline segments; and updating the polyline-segment feature comprises smoothing the polyline-segment feature of the plurality of polyline segments based on the other polyline segment.
Aspect 23. The method of aspect 22, wherein smoothing the polyline-segment feature comprises smoothing the polyline-segment feature based on a graph neural network (GNN), wherein the GNN is based on the plurality of polyline segments.
Aspect 24. The method of any one of aspects 15 to 23, wherein the relationship is determined using an attention mechanism.
Aspect 25. The method of any one of aspects 15 to 24, further comprising: processing the point-cloud representation of the scene to generate a plurality of point-cloud features; and combining at least one polyline-segment feature of the plurality of polyline-segment features with at least one point-cloud feature of the plurality of point-cloud features to generate at least one combined feature; wherein determining the relationship is determined based on the at least one combined feature.
Aspect 26. The method of aspect 25, further comprising processing the point-cloud representation to generate a plurality of voxels prior to combining the at least one polyline-segment feature with the at least one point-cloud feature.
Aspect 27. The method of any one of aspects 15 to 26, wherein the plurality of polyline segments are processed to generate the plurality of polyline-segment features using a machine-learning-model encoder.
Aspect 28. The method of any one of aspects 15 to 27, wherein the plurality of polyline-segment features are processed to generate a refined polyline trajectory using a machine-learning-model decoder.
Aspect 29. A non-transitory computer-readable storage medium having stored thereon instructions that, when executed by at least one processor, cause the at least one processor to perform operations according to any of aspects 15 to 28.
Aspect 30. An apparatus for providing virtual content for display, the apparatus comprising one or more means for perform operations according to any of aspects 15 to 28.
Aspect 31. The apparatus of any of aspects 1 to 14, wherein the apparatus is a computing device of a vehicle.
Aspect 32. The apparatus of aspect 31, wherein the at least one processor is configured to adjust an operating parameter of the vehicle based on the refined polyline trajectory.
Aspect 33. The apparatus of aspect 32, wherein the operating parameter is associated with at least one of a path for the vehicle to travel, an automatic-braking parameter for operating one or more brakes of the vehicle, a lane-change parameter for causing the vehicle to navigate from a first lane to a second lane, or displaying information using a user interface of the vehicle.
Aspect 34. The method of any of aspects 15 to 30, wherein the method is implemented by a computing device of a vehicle.
Aspect 35. The method of aspect 34, further comprising adjusting an operating parameter of the vehicle based on the refined polyline trajectory.
Aspect 36. The apparatus of aspect 35, wherein the operating parameter is associated with at least one of a path for the vehicle to travel, an automatic-braking parameter for operating one or more brakes of the vehicle, a lane-change parameter for causing the vehicle to navigate from a first lane to a second lane, or displaying information using a user interface of the vehicle.

What is claimed is:

1. An apparatus for refining polylines, the apparatus comprising:
at least one memory; and
at least one processor coupled to the at least one memory and configured to:
generate a polyline trajectory based on a point-cloud representation of a scene;
generate a plurality of polyline segments based on the polyline trajectory;
process the plurality of polyline segments to generate a plurality of polyline-segment features;
determine a relationship associated with polylines of the polyline trajectory based on the plurality of polyline-segment features;
update a polyline-segment feature of the plurality of polyline-segment features based on the relationship; and
process the plurality of polyline-segment features to generate a refined polyline trajectory.

2. The apparatus of claim 1, wherein the at least one processor is configured to resample each polyline segment of the plurality of polyline segments prior to processing the plurality of polyline segments.

3. The apparatus of claim 2, wherein the at least one processor is configured to resample each polyline segment using spline interpolation.

4. The apparatus of claim 1, wherein the at least one processor is configured to encode the plurality of polyline segments using a multi-layer perceptron (MLP).

5. The apparatus of claim 1, wherein:
the relationship comprises a relationship between points of a polyline segment of the plurality of polyline segments; and
to update the polyline-segment feature, the at least one processor is configured to smooth the polyline-segment feature of the plurality of polyline-segment features based on the points of the polyline segment.

6. The apparatus of claim 5, wherein the at least one processor is configured to smooth the polyline-segment feature based on a turn angle.

7. The apparatus of claim 1, wherein:
the relationship comprises a relationship between a polyline segment of the plurality of polyline segments and another polyline segment of the plurality of polyline segments; and
to update the polyline-segment feature, the at least one processor is configured to smooth the polyline-segment feature of the plurality of polyline segments based on the other polyline segment.

8. The apparatus of claim 1, at least one processor coupled to the at least one memory and configured to:
process the point-cloud representation of the scene to generate a plurality of point-cloud features; and
combine at least one polyline-segment feature of the plurality of polyline-segment features with at least one point-cloud feature of the plurality of point-cloud features to generate at least one combined feature;
wherein the at least one processor is configured to determine the relationship based on the at least one combined feature.

9. The apparatus of claim 8, wherein the at least one processor is configured to process the point-cloud representation to generate a plurality of voxels prior to combining the at least one polyline-segment feature with the at least one point-cloud feature.

10. The apparatus of claim 1, wherein the at least one processor is configured to process the plurality of polyline segments to generate the plurality of polyline-segment features using a machine-learning-model encoder.

11. The apparatus of claim 1, wherein the at least one processor is configured to process the plurality of polyline-segment features to generate the refined polyline trajectory using a machine-learning-model decoder.

12. The apparatus of claim 1, wherein the apparatus is a computing device of a vehicle.

13. The apparatus of claim 12, wherein the at least one processor is configured to adjust an operating parameter of the vehicle based on the refined polyline trajectory.

14. The apparatus of claim 13, wherein the operating parameter is associated with at least one of a path for the vehicle to travel, an automatic-braking parameter for operating one or more brakes of the vehicle, a lane-change parameter for causing the vehicle to navigate from a first lane to a second lane, or displaying information using a user interface of the vehicle.

15. A method for refining polylines, the method comprising:
generating a polyline trajectory based on a point-cloud representation of a scene;
generating a plurality of polyline segments based on the polyline trajectory;
processing the plurality of polyline segments to generate a plurality of polyline-segment features;
determining a relationship associated with polylines of the polyline trajectory based on the plurality of polyline-segment features;
updating a polyline-segment feature of the plurality of polyline-segment features based on the relationship; and
processing the plurality of polyline-segment features to generate a refined polyline trajectory.

16. The method of claim 15, further comprising resampling each polyline segment of the plurality of polyline segments prior to processing the plurality of polyline segments.

17. The method of claim 16, wherein each polyline segment is resampled using spline interpolation.

18. The method of claim 15, wherein the plurality of polyline segments are encoded using a multi-layer perceptron (MLP).

19. The method of claim 15, wherein:
the relationship comprises a relationship between points of a polyline segment of the plurality of polyline segments; and
updating the polyline-segment feature comprises smoothing the polyline-segment feature of the plurality of polyline-segment features based on the points of the polyline segment.

20. The method of claim 19, wherein the polyline-segment feature is smoothed based on a turn angle.
